(19) United States
(12) Patent Application Publication
(10) Pub. No.: US 2020/0385185 A1
(43) Pub. Date: Dec. 10, 2020

(54) DISPOSABLE BEVERAGE LID AND DISPOSABLE BEVERAGE CONTAINER SYSTEM AND METHOD

(71) Applicant: NIETO PRODUCTS, LLC, Norman, OK (US)

(72) Inventor: James Greg Nieto, Norman, OK (US)

(21) Appl. No.: 16/432,434

(22) Filed: Jun. 5, 2019

(51) Int. Cl. B65D 65/40; B32B 27/10; B32B 7/12

(52) U.S. Cl. CPC B65D 65/40; B32B 2435/02; B32B 7/12; B32B 27/10

(57) ABSTRACT

A disposable beverage lid for use in combination with a disposable beverage container. The disposable beverage lid including a flexible membrane having a top side and a bottom side. The bottom side coated with a pressure sensitive adhesive. The disposable beverage lid including a first flexible release liner having a top side coated with a release agent and a bottom side coated with a pressure sensitive adhesive. The top side of the first flexible release liner detachably connected to the bottom side of the flexible membrane. The disposable beverage lid including a second flexible release liner having a top side coated with a release agent and a bottom side. The top side of the second flexible release liner detachably connected to the bottom side of the first flexible release liner.

### FIELD OF INVENTION

The invention is in the technical field of disposable beverage lids and disposable beverage containers. The invention pertains generally to disposable beverage lids and disposable beverage container systems, methods of use and methods of manufacture, the combination of which create the invention described and claimed herein.

### BACKGROUND

Traditional disposable beverage lids and disposable beverage containers, such as those commonly used for take-out orders of coffee, soda, tea, water and the like, are well known in the art. Traditional disposable beverage lids are configured to prevent the contents of the disposable beverage container from spilling out of an opening during normal use and are often formed from a rigid paper or plastic material. For example, plastic thermoformed lids which snap over the top and exterior of a disposable beverage container containing a lip are well known in the art. Other traditional means to secure a disposable lid to a beverage container include threaded screw closure mechanisms and gasket mechanisms Generally, traditional disposable beverage lids and traditional disposable beverage containers are configured and sized in a complementary manner so the disposable beverage lid will sufficiently seal the opening of the disposable beverage container and prevent the contents of the disposable beverage container from spilling during normal use.

Unfortunately, however, such traditional disposable beverage lids and traditional disposable beverage containers have numerous disadvantages, including, for example, the cost to manufacture, inconvenience of use, cleanliness, biodegradability and lack of versatility with a wide range of disposable beverage container sizes, shapes and configurations. For example, a user is often required to make two separate trips to a trash receptacle, one trip to dispose of the disposable beverage lid and a second trip to dispose of the disposable beverage container itself. Thus, decreasing the usefulness of the disposable beverage lid and the disposable beverage container. Further, traditional disposable beverage containers and traditional disposable lids are configured so that the disposable lid, when not in use and if not properly discarded, is often placed on a surface, such as a table or chair, near the beverage container. Thus, increasing the likelihood that the contents of the beverage container will inadvertently transfer onto the surface. Thereby reducing the cleanliness and overall effectiveness of the disposable beverage lid and disposable beverage container system. Moreover, traditional disposable beverage containers and traditional disposable beverage lids are often formed from a rigid material of a pre-formed size and shape that is only suitable for use with a certain type, size and shape disposable beverage container, thus increasing the overall cost associated with manufacturing multiple sized and shaped disposable beverage lids and decreasing the utility of each specifically sized and shaped disposable beverage lid.

To that end it would be advantageous to provide an improved disposable beverage lid that is efficient to manufacture, convenient to use, clean, biodegradable and which may be used with a wide range of disposable beverage container sizes, shapes and configurations. It is to such an improved disposable beverage lid, disposable beverage container, system, product and to methods for manufacturing and methods for using thereof that exemplary embodiments of the inventive concepts disclosed and claimed herein are directed.

### SUMMARY OF THE INVENTION

The inventive concepts disclosed and claimed herein are generally directed to embodiments of a disposable beverage lid that includes a flexible membrane having a top side and a bottom side. The bottom side coated with a pressure sensitive adhesive. The disposable beverage lid including a first flexible release liner having a top side coated with a release agent and a bottom side coated with a pressure sensitive adhesive. The top side of the first flexible release liner detachably connected to the bottom side of the flexible membrane. The disposable beverage lid also including a second flexible release liner having a top side coated with a release agent and a bottom side. The top side of the second flexible release liner detachably connected to the bottom side of the first flexible release liner.

Wherein, the first flexible release liner is configured to be peeled away from the second flexible release liner and attached to a side of the disposable beverage container such that a user may selectively remove the flexible membrane from the side of the disposable beverage container and affix the flexible membrane over the top of an opening on the disposable beverage container to substantially prevent the contents of the disposable beverage container from spilling. Further, a user may also selectively remove the flexible membrane from the opening of the disposable beverage container and affix the flexible membrane back on the side of the disposable beverage container.

For example, a user may “stick” the disposable beverage lid to a side of the disposable beverage container. Then, when a user desires to cover the opening of the disposable beverage container, such as for example, when walking or traveling in a vehicle, the user peels the flexible membrane off the side of the disposable beverage container and sticks the flexible membrane over the top of the opening of the disposable beverage container. Then, when a user desires to remove the flexible membrane from the opening of the disposable beverage container, such as for example, when drinking from the disposable beverage container, the user peels the flexible membrane off the opening of the disposable beverage and sticks the flexible membrane back onto a side of the disposable beverage, so that the disposable beverage lid may be reused or thrown away and stored in conjunction with the disposable beverage container. In some embodiments, the flexible membrane is formed from a material that may be pierced by a straw or the like to create a smaller opening for drinking while the flexible membrane covers the opening.

Because the disposable beverage lid is affixed to a side of the disposable beverage container when not in use, a user only needs to visit a trash receptacle one time to throw away both the disposable beverage lid and the disposable beverage container. Further, because the disposable beverage lid is affixed to a side of the disposable beverage container, there is no need to place the disposable beverage lid on a nearby surface when the disposable beverage lid is not in use. Thereby increasing the cleanliness and effectiveness of the disposable lid and disposable beverage container. In addition, because the flexible membrane is configured to be affixed over the beverage container opening by means of a pressure sensitive adhesive, the disposable beverage lid may be used with a variety of different sized and shaped disposable beverage containers. Thereby eliminating the need for manufacturing a variety of preformed specific sized and specific shaped disposable beverage lids to cover specific sized or shaped disposable beverage containers. Further, because the disposable beverage lid is configured to be formed in a thin flexible shape, the disposable beverage lid can be affixed to the side of the disposable beverage container without interfering with the normal use and handling of the disposable beverage container. Thereby, improving the convenience of the disposable beverage lid and decreasing the cost to manufacture, store and ship as compared to traditional pre-formed rigid disposable beverage lids. For example because the disposable beverage lid is thin and flexible, a plurality of disposable beverage lids may be manufactured to be pre-formed on a sheet and rolled so that a user may selectively tear a disposable beverage lid from the roll when needed, and then affix the disposable beverage lid to a side of a disposable beverage container. In contrast, traditional pre-formed rigid disposable beverage lids are often shipped and stored in stacks, which take up more space than thin rolled sheets, for example.

In one embodiment, a sheet of a plurality of pre-formed disposable beverage lids is disclosed. Each disposable beverage lid for use in combination with a disposable beverage container. The sheet including a layer of a plurality of perforated flexible membranes having a top side and a bottom side, the bottom side coated with a pressure sensitive adhesive. The sheet including a layer of a plurality of perforated first flexible release liners having a top side coated with a release agent and a bottom side coated with a pressure sensitive adhesive. The top side of the perforated first flexible release liners detachably connected to the bottom side of the perforated flexible membranes. The sheet also including a layer of a plurality of perforated second flexible release liners having a top side coated with a release agent and a bottom side. The top side of the perforated second flexible release liners detachably connected to the bottom side of the perforated first flexible release liners.

In another embodiment, a method of making a disposable beverage lid is disclosed. The disposable beverage lid for use in combination with a disposable beverage container. The method including the step of forming a layer of a plurality of perforated flexible membranes having a top side and a bottom side. The bottom side coated with a pressure sensitive adhesive. The method including the step of forming a layer of a plurality of perforated first flexible release liners having a top side coated with a release agent and a bottom side coated with a pressure sensitive adhesive. The top side of the perforated first flexible release liners detachably connected to the bottom side of the perforated flexible membranes. The method also including the step of forming a layer of a plurality of perforated second flexible release liners having a top side coated with a release agent and a bottom side. The top side of the perforated second flexible release liners detachably connected to the bottom side of the perforated first flexible release liners.

### BRIEF DESCRIPTION OF THE SEVERAL VIEWS OF THE DRAWINGS

Like reference numerals in the figures represent and refer to the same or similar element or function. Implementations of the disclosure may be better understood when consideration is given to the following detailed description thereof. Such description makes reference to the annexed pictorial illustrations, schematics, graphs, drawings, and appendices. In the drawings:

FIG. 1 is a side view of a disposable beverage lid (100) in accordance with the inventive concepts disclosed herein.

FIG. 2 is a top view of a disposable beverage lid (100) affixed to a side of a beverage container (105) in accordance with the inventive concepts disclosed herein.

FIG. 3 is a side view of a disposable beverage lid (100) affixed to a side of a beverage container (105) in accordance with the inventive concepts disclosed herein.

FIG. 4 is a side view of a disposable beverage lid (100) depicting the flexible membrane (120) affixed over the opening of a disposable beverage container (105) in accordance with the inventive concepts disclosed herein.

FIG. 5 is a top view of a sheet (200) of a plurality of pre-formed disposable beverage lids (100) in accordance with the inventive concepts disclosed herein.

FIG. 6 is a side view of a sheet (200) of a plurality of pre-formed disposable beverage lids (100) in accordance with the inventive concepts disclosed herein.

FIG. 7 is a diagram of a method (300) of making a disposable beverage lid (100) in accordance with the inventive concepts disclosed herein.

### DETAILED DESCRIPTION OF EXEMPLARY EMBODIMENTS

Before explaining at least one embodiment of the inventive concepts disclosed herein in detail, it is to be understood that the inventive concepts are not limited in their application to the details of construction and the arrangements of the components or steps or methodologies set forth in the following description or illustrated in the drawings. The inventive concepts disclosed herein are capable of other embodiments or of being practiced or carried out in various ways. Also, it is to be understood that the phraseology and terminology employed herein is for the purpose of description and should not be regarded as limiting the inventive concepts claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, well-known features have not been described in detail to avoid unnecessarily complicating the instant disclosure.

As used herein, the terms “comprises,” “comprising,” “includes,” “including,” “has,” “having,” or any other variation thereof, are intended to cover a non-exclusive inclusion. For example, a system, process, method, article, or apparatus that comprises a list of elements is not necessarily limited to only those elements but may include other elements not expressly listed.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

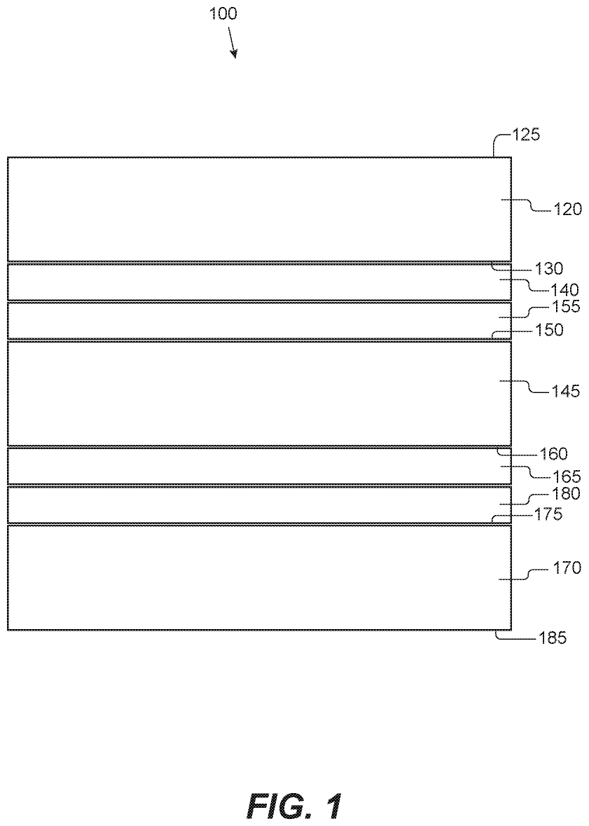

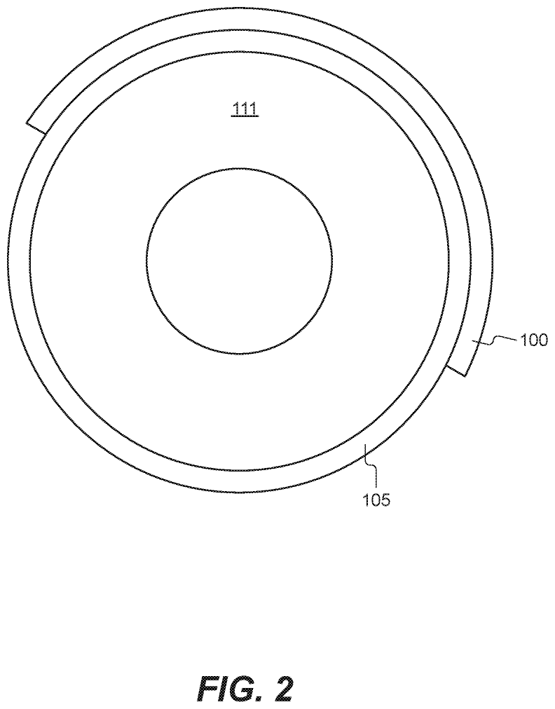

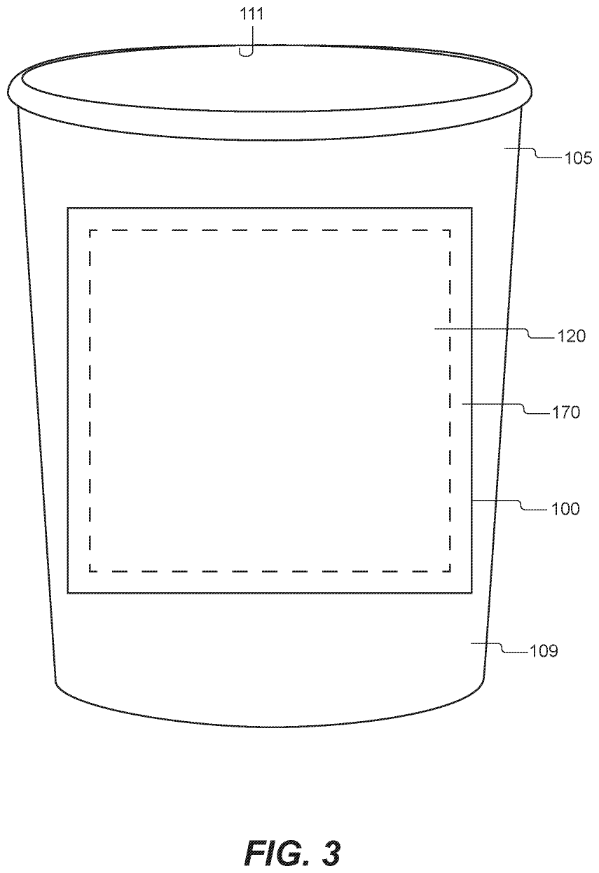

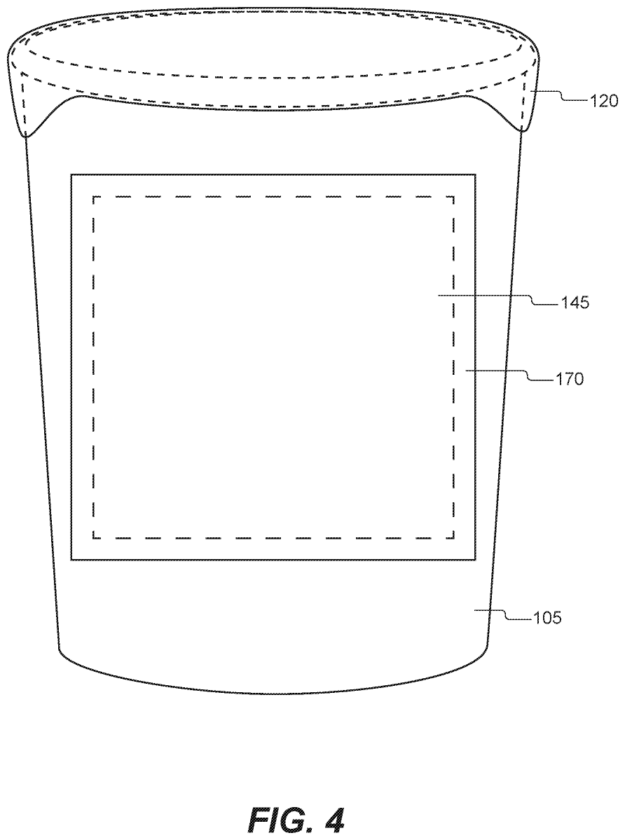

Referring now to FIGS. 1-4, shown therein is an embodiment of the disposable beverage lid (100). FIG. 1 depicts a side view of the disposable beverage lid (100) for use in combination with a disposable beverage container (105). FIG. 2 is a top view of the disposable beverage lid (100) affixed to a side of a beverage container (105) in accordance with the inventive concepts disclosed herein. FIG. 3 depicts a side view of the disposable beverage lid (100) affixed to a side of a beverage container (105) in accordance with the inventive concepts disclosed herein. FIG. 4 is a side view of the disposable beverage lid (100) depicting the flexible membrane (120) affixed over the opening of the disposable beverage container (105) in accordance with the inventive concepts disclosed herein.

As shown therein, the disposable beverage lid (100) includes a flexible membrane (120) having a top side (125) and a bottom side (130). The bottom side (130) coated with a pressure sensitive adhesive (140). The disposable beverage lid (100) includes a first flexible release liner (145) having a top side (150) coated with a release agent (155) and a bottom side (160) coated with a pressure sensitive adhesive (165). The top side (150) of the first flexible release liner (145) is, detachably connected to the bottom side (130) of the flexible membrane (120). The disposable beverage lid (100) further includes a second flexible release liner (170) having a top side (175) coated with a release agent (180) and a bottom side (185). The top side (175) of the second flexible release liner (170) is detachably connected to the bottom side (160) of the first flexible release liner (145).

Wherein, the first flexible release liner (145) is configured to be peeled away from the second flexible release liner (170) and attached to a side (109) of the disposable beverage container (105), such that a user may selectively remove the flexible membrane (120) from the side (109) of the disposable beverage container (105) and affix the flexible membrane (120) over an opening (111) on the disposable beverage container (105) to substantially prevent the contents of the disposable beverage container (105) from spilling and such that a user may selectively remove the flexible membrane (120) from the opening (111) of the disposable beverage container (105) and affix the flexible membrane (120) back on the side (109) of the disposable beverage container (105). The disposable beverage container (105) is shown as having a side (109) and an opening (111). It should be understood that the disposable beverage lid (100) is configured to be used with a variety of different sized and shaped beverage containers, including but not limited to beverage container (105) for example.

The disposable beverage lid (100) may be constructed from any desired material that is sufficiently flexible including but not limited to, paper, plastic, polymers, metals, non-metals, alloys, resins, composite materials, organic compounds, non-organic compounds, fabrics, combinations thereof and the like. In some embodiments, the disposable beverage lid (100) may have a thickness of approximately 0.01 mm. While in other embodiments, the disposable beverage lid (100) may have a thickness of less than 0.01 mm or greater than 0.01 mm, depending upon the desired thickness of the disposable beverage lid (100). While, a thickness of approximately 0.01 mm is preferred for the disposable beverage lid (100), it should be understood that the disposable beverage lid (100) may be constructed from any material that is sufficiently flexible to wrap around the outside of a disposable beverage container and to create a barrier to prevent liquids from spilling out of the disposable beverage lid (100) when in use as described herein.

Further, in some embodiments, the disposable beverage lid (100) may also include reinforcing or bracing structures, such as struts, ribs, braces, rods or any other suitable reinforcing or bracing structure, or combinations thereof. The shape of the disposable beverage lid (100) is shown as having a generally rectangular or square shape. It should be understood, however, that the shape of the disposable beverage lid (100) may be any desired shape, including but not limited to, a circular, triangular or any other desired shape sufficient to permit the disposable beverage lid (100) to function as described herein.

The disposable beverage lid (100) includes a flexible membrane (120). The flexible membrane (120) has a top side (125) and a bottom side (130). The bottom side (130) of the flexible membrane (120) is coated with a pressure sensitive adhesive (140). The flexible membrane (120) may be constructed from any substantially thin and flexible material sufficient to stretch across an opening of a beverage container and create a barrier capable of preventing liquids, such as water, soda, tea and the like from spilling out of the beverage container during normal use. For example, the flexible membrane (120) may be formed from paper, plastic, hydrophobic polytetrafluoroethylene (PTFE), polymers, polypropylene, biaxial oriented polypropylene (BOPP) film, thermoplastic polymers, vinyl, such as static cling vinyl, opaque vinyl, clear vinyl, clear polyester, combinations thereof and the like. The flexible membrane (120) may be non-porous or semi-porous so as to permit gases to pass through the flexible membrane (120); provided however, that any pores in the flexible membrane (120) must be configured to substantially prevent liquids from passing through the flexible membrane (120) during normal use. In some embodiments, the flexible membrane (120) may also have reinforcement or lamination, including reinforcement or lamination to add durability and UV protection, for example.

The bottom side (130) of the flexible membrane (120) is coated with a pressure sensitive adhesive (140). The pressure sensitive adhesive (140) is a coating or thin layer of adhesive material that is sufficient to permit the flexible membrane (120) to stick to the side of a disposable beverage container and stick to and cover the opening of the disposable beverage container. The adhesive material is a non-reactive adhesive which forms a bond when pressure is applied to bond the adhesive with the adherend. No solvent, water or heat is needed to activate the adhesive for the pressure sensitive adhesive (140). However, it should be understood to one of ordinary skill in the art that other types of adhesives may be used with the flexible membrane (120), including, for example, structural, chemical or heat adhesives and the like.

The degree of the bond for the pressure sensitive adhesive (140) may be influenced by the amount of pressure which is used to apply the pressure sensitive adhesive to the surface. Surface factors such as smoothness, surface energy, and removal of contaminants are also important to create proper bonding. As will be appreciated by one of ordinary skill in the art, pressure sensitive adhesives are generally designed with a balance between flow and resistance to flow. The bond forms because the adhesive is soft enough to flow, or wet, the adherend. The bond has strength because the adhesive is hard enough to resist flow when stress is applied to the bond. Once the adhesive and the adherend are in proximity, there are also molecular interactions such as van der Waals forces involved in the bond, which contribute significantly to the ultimate bond strength.

Because some pressure sensitive adhesives reduce their shear holding ability at low or high temperatures (temperatures significantly above or below standard room temperature of 73.4 degrees Fahrenheit), the pressure sensitive adhesive (140) is configured to retain its bond even when placed on the side of a beverage container that may contain a hot beverage, such as hot coffee, hot chocolate or the like or a cold beverage such as ice water for example. The pressure sensitive adhesive (140) also exhibits viscoelastic (viscous and elastic) properties, both of which are used for proper bonding. In contrast to structural adhesives, whose strength is evaluated as lap shear strength, pressure-sensitive adhesives are generally characterized by their shear and peel resistance as well as their initial tack, for example. These properties are dependent, among other things, on the formulation, coating thickness, rub-down and temperature for example.

The pressure sensitive adhesive (140) may be constructed with either a liquid carrier or in solid form. The pressure sensitive adhesive (140) may be made from liquid pressure sensitive adhesives by coating the adhesive on a support and evaporating the organic solvent or water carrier, usually in a hot air dryer, for example. The dry adhesive may be further heated to initiate a cross-linking reaction and increase molecular weight. Solid pressure sensitive adhesives may be low viscosity polymers that are coated and then reacted with radiation to increase molecular weight and form the adhesive (radiation cured pressure sensitive adhesives); or they may be high-viscosity materials that are heated to reduce viscosity enough to allow coating, and then cooled to their final form (hot melt pressure sensitive adhesives).

The pressure sensitive adhesive (140) may be based on an elastomer compounded with a suitable tackifier (e.g., a rosin ester). The elastomers can be based on acrylics, which can have sufficient tack on their own and may not require a tackifier; bio-based acrylate, butyl rubber, ethylene-vinyl acetate (EVA) with high vinyl acetate content; can be formulated as a hot-melt pressure sensitive adhesive, natural rubber, nitriles, silicone rubbers, requiring special tackifiers based on “MQ” silicate resins, composed of a monofunctional trimethyl silane (“M”) reacted with quadrafunctional silicon tetrachloride (“Q”).

Further, the pressure sensitive adhesive (140) may include styrene block copolymers (SBC), also called styrene copolymer adhesives and rubber-based adhesives, which have good low-temperature flexibility, high elongation, and, high heat resistance. Such compounds may have an A-B-A structure, including an elastic rubber segment between two rigid plastic endblocks; high-strength film formers which increase cohesion and viscosity as an additive; and may be water-resistant, with cross-linking to improve solvent resistance. Resins associating to the end blocks (cumarone-indene, α-methyl styrene, vinyl toluene, aromatic hydrocarbons, etc.) improve adhesion and alter viscosity. Resins associating to the mid blocks (aliphatic olefins, rosin esters, polyterpenes, terpene phenolics) also improve adhesion, processing and pressure-sensitive properties. The addition of plasticizers reduces cost, improves pressure-sensitive tack, decrease melt viscosity, decreases hardness, and improves low-temperature flexibility. The A-B-A structure promotes a phase separation of the polymer, binding together the end blocks, with the central elastic parts acting as cross-links; SBCs may also include additional cross-linking, styrene-butadiene-styrene (SBS), which may be used in high-strength pressure sensitive adhesive applications or styrene-ethylene/butylene-styrene (SEBS), used in low self-adhering non-woven applications, or styrene-ethylene/propylene (SEP) and styrene-isoprene-styrene (SIS), used in low-viscosity high-tack pressure sensitive adhesive applications, including vinyl ethers, for example.

The disposable beverage lid (100) further includes a first flexible release liner (145). The first flexible release liner (145) has a top side (150) coated with a release agent (155) and a bottom side (160) coated with a pressure sensitive adhesive (165). The top side (150) of the first flexible release liner (145) detachably connected to the bottom side (130) of the flexible membrane (120). The disposable beverage lid (100) further includes a second flexible release liner (170). The second flexible release liner (170) having a top side (175) coated with a release agent (180) and a bottom side (185). The top side (175) of the second flexible release liner (170) detachably connected to the bottom side (160) of the first flexible release liner (145).

The first flexible release liner (145) and the second flexible release liner (170) are formed from a paper or plastic based film sheet (which is typically applied during the manufacturing process) used to prevent a sticky surface from prematurely adhering. It is coated on one or both sides with a release agent (such as release agent (180)), which provides a release effect against any type of a sticky material such as an adhesive or a mastic. The term “release” is commonly used by those of ordinary skill in the art to refer to a separation of the liner from a sticky material, whereas the “liner” is often referred to as the carrier for the release agent.

As will be appreciated by one of ordinary skill in the art having the benefit of the instant disclosure, the liner material may be constructed from a variety of substrates, which are the carrier materials of the release agent. Liner materials include, but are not limited to, paper, such as, super calendered kraft paper (SCK), glassine, which is also a SCK paper but typically provided with a polyvinyl alcohol (PVOH) top coat, clay coated kraft paper (CCK), machine finished kraft paper (MFK), machine glazed paper (MG), which has been glazed, e.g., on a yankee cylinder of a paper machine for example. Plastic film, which includes BO-PET, a PET film (biaxially oriented) is a high temperature resistant and tough film liner, BOPP, a biaxially oriented PP film, other polyolefins, typically made out of HDPE, LDPE, PP plastic resins, for example. Plastic films may be made by a plastics extrusion process out of plastic resins and can be made out of one single type of plastic material, a blend of different plastic materials or multilayered coextrusions. Other papers may be used for the liner material, including, poly coated kraft papers, which are typically MFK papers have on one or both, sides a poly olefin coating, to make them very smooth, moisture resistant and dimensionally stable.

As one of ordinary skill in the art having the benefit of the instant disclosure will appreciate, the pressure sensitive adhesive (165) is formed and constructed similar to the pressure sensitive adhesive (140) described herein and will not be described further for purposes of brevity. In addition, as one of ordinary skill in the art having the benefit of the instant disclosure will appreciate, the release agent (180) is formed and constructed similar to the release agent (155) described herein and will not be described further in detail for purposes of brevity. It being understood, that the release agent (180) and release agent (155) may be a silicone release agent configured to help the adhesive release easier when pulled by a user. A variety of silicone release agents are known in the art, including, but not limited to, solvent-less addition cure, solvent addition cure, emulsion addition cure, non-solvent UV-cure release agents, for example.

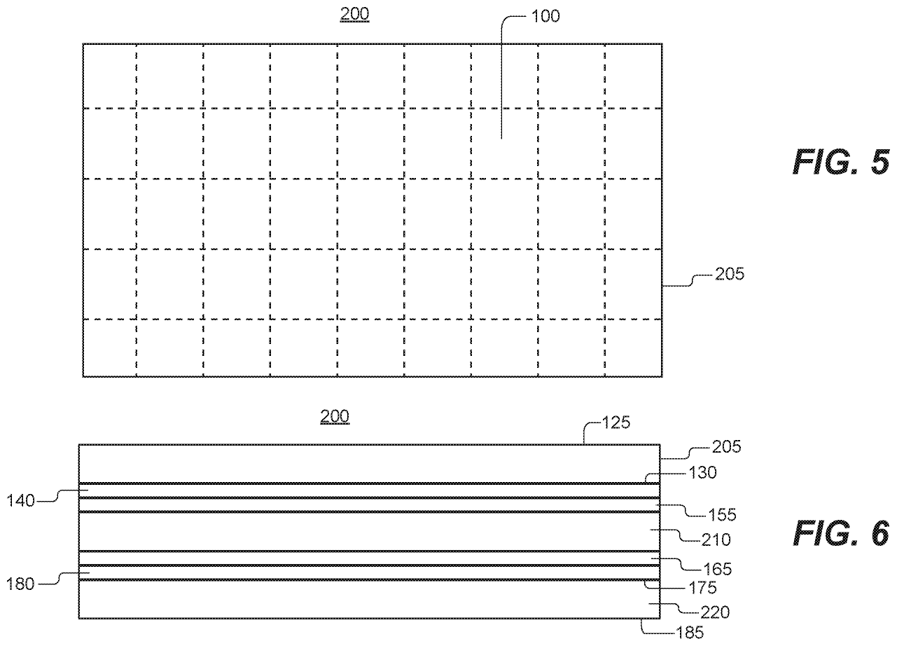

Referring now to FIG. 5-6, shown therein is a sheet (200) of a plurality of pre-formed disposable beverage lids (100) in accordance with the inventive concepts disclosed herein. FIG. 5 depicts a top view of the sheet (200) of a plurality of pre-formed disposable beverage lids (100) in accordance with the inventive concepts disclosed herein. FIG. 6 depicts a side view of the sheet (200) of a plurality of pre-formed disposable beverage lids (100) in accordance with the inventive concepts disclosed herein. Each disposable beverage lid (100) is configured for use in combination with a disposable beverage container (105).

The sheet (200) includes a layer (205) of a plurality of perforated flexible membranes (120). Each perforated flexible membrane (120) having a top side (125) and a bottom side (130). The bottom side (130) coated with a pressure sensitive adhesive (140). The sheet (200) includes a layer (210) of a plurality of perforated first flexible release liners (145). Each perforated first flexible release liner (145) has a top side (150) coated with a release agent (155) and a bottom side (160) coated with a pressure sensitive adhesive (165). The top side (150) of the perforated first flexible release liners (145) are detachably connected to the bottom side (130) of the perforated flexible membranes (120). The sheet (200) further includes a layer (220) of a plurality of perforated second flexible release liners (170). Each perforated second flexible release liner (170) having a top side (175) coated with a release agent (180) and a bottom side (185). The top side (175) of the perforated second flexible release liners (170) is detachably connected to the bottom side (160) of the perforated first flexible release liners (145).

The sheet (200) of a plurality of pre-formed disposable beverage lids (100) is configured to be rolled for convenient storage, shipping and use. The layer (205) of a plurality of perforated flexible membranes (120), layer (210) of a plurality of perforated first flexible release liners (145) and layer (220) of a plurality of perforated second flexible release liners (170) are formed and constructed as described above and will not be repeated for purposes of brevity.

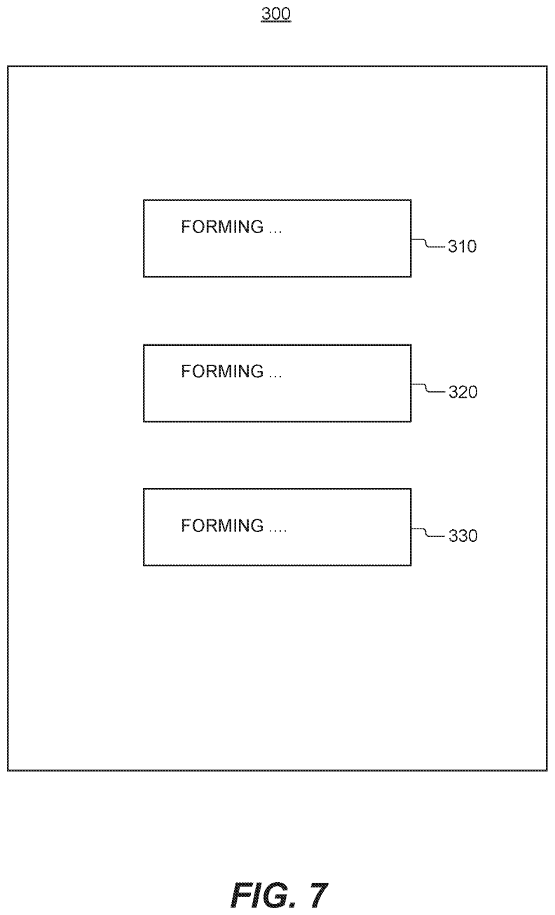

Referring now to FIG. 7, shown therein is a method (300) of making a disposable beverage lid (100). The method (300) for use in combination with a disposable beverage container (105). The method (300) including the step of forming (310) a layer of a plurality of perforated flexible membranes (120) having a top side (125) and a bottom side (130). The bottom side (130) coated with a pressure sensitive adhesive (140). The method (300) including the step of forming (320) a layer of a plurality of perforated first flexible release liners (145) having a top side (150) coated with a release agent (155) and a bottom side (160) coated with a pressure sensitive adhesive (140). The top side (150) of the perforated first flexible release liners (145) is detachably connected to the bottom side (160) of the perforated flexible membranes (120). The method (300) further including the step of forming (330) a layer of a plurality of perforated second flexible release liners (170). Each perforated second flexible release liner (170) having a top side (175) coated with a release agent (180) and a bottom side (185). The top side (175) of the perforated second flexible release liners (170) are detachably connected to the bottom side (160) of the perforated first flexible release liners (145).

From the above description it is clear that the inventive concepts disclosed herein are adapted to carry out the objects and to attain the advantages mentioned herein as well as those inherent in the inventive concepts disclosed herein. While exemplary embodiments of the inventive concepts disclosed herein have been described for purposes of this disclosure, it will be understood that numerous changes may be made which will readily suggest themselves to those skilled in the art and which are accomplished within the broad scope of the inventive concepts disclosed herein and defined by the appended claims.

What is claimed is:

1. A disposable beverage lid for use in combination with a disposable beverage container, the disposable beverage lid comprising:
a flexible membrane having a top side and a bottom side, the bottom side coated with a pressure sensitive adhesive;
a first flexible release liner having a top side coated with a release agent and a bottom side coated with a pressure sensitive adhesive, the top side of the first flexible release liner detachably connected to the bottom side of the flexible membrane; and
a second flexible release liner having a top side coated with a release agent and a bottom side, the top side of the second flexible release liner detachably connected to the bottom side of the first flexible release liner;
wherein the first flexible release liner is configured to be peeled away from the second flexible release liner and attached to a side of the disposable beverage container such that a user may selectively remove the flexible membrane from the side of the disposable beverage container and affix the flexible membrane over an opening on the disposable beverage container to substantially prevent the contents of the disposable beverage container from spilling and such that a user may selectively remove the flexible membrane from the opening of the disposable beverage container and affix the flexible membrane back on the side of the disposable beverage container.

2. A sheet of a plurality of pre-formed disposable beverage lids, each disposable beverage lid for use in combination with a disposable beverage container, the sheet comprising:
a layer of a plurality of perforated flexible membranes having a top side and a bottom side, the bottom side coated with a pressure sensitive adhesive;
a layer of a plurality of perforated first flexible release liners having a top side coated with a release agent and a bottom side coated with a pressure sensitive adhesive, the top side of the perforated first flexible release liners detachably connected to the bottom side of the perforated flexible membranes; and
a layer of a plurality of perforated second flexible release liners having a top side coated with a release agent and a bottom side, the top side of the perforated second flexible release liners detachably connected to the bottom side of the perforated first flexible release liners.

3. A method of making a disposable beverage lid, for use in combination with a disposable beverage container, the method comprising the steps of:
forming a layer of a plurality of perforated flexible membranes having a top side and a bottom side, the bottom side coated with a pressure sensitive adhesive;
forming a layer of a plurality of perforated first flexible release liners having a top side coated with a release agent and a bottom side coated with a pressure sensitive adhesive, the top side of the perforated first flexible release liners detachably connected to the bottom side of the perforated flexible membranes; and
forming a layer of a plurality of perforated second flexible release liners having a top side coated with a release agent and a bottom side, the top side of the perforated second flexible release liners detachably connected to the bottom side of the perforated first flexible release liners.
